(19) United States
(12) Patent Application Publication
(10) Pub. No.: US 2017/0373605 A1
(43) Pub. Date: Dec. 28, 2017

(54) INDUCTIVE POWER RECEIVER

(71) Applicant: PowerbyProxi Limited, Freemans Bay, Auckland (NZ)

(72) Inventors: Lawrence Bernardo DELA CRUZ, Freemans Bay, Auckland (NZ); Ron Rafer FLORESCA, Freemans Bay, Auckland (NZ)

(73) Assignee: PowerbyProxi Limited, Freemans Bay, Auckland (NZ)

(21) Appl. No.: 15/534,713

(22) PCT Filed: Dec. 9, 2015
(86) PCT No.: PCT/NZ2015/050210

§ 371 Date: Jun. 9, 2017

Related U.S. Application Data
(60) Provisional application No. 62/089,472, filed on Dec. 9, 2014.

(51) Int. Cl. H02M 3/335; H01F 38/14; H01F 27/28; H02J 7/02; H02J 50/12

(52) U.S. Cl. CPC H02M 3/33576; H02J 7/025; H02J 50/12; H01F 27/2804; H01F 38/14

(57) ABSTRACT

An inductive power receiver 3 comprising: a power pick up stage 9; and a power rectification and regulation stage 10 including a rectifier having a plurality of control devices, wherein at least one of the control devices is a controllable AC switch, wherein the receiver is configured to switch the at least one AC switch according to an open circuit control strategy.

### FIELD

This invention relates generally to a converter, particularly though not solely, to a converter for an inductive power receiver.

### BACKGROUND

Electrical converters are found in many different types of electrical systems. Generally speaking, a converter converts a supply of a first type to an output of a second type. Such conversion can include DC-DC, AC-AC and DC-AC electrical conversions. In some configurations a converter may have any number of DC and AC ‘parts’, for example a DC-DC converter might incorporate an AC-AC converter stage in the form of a transformer.

One example of the use of converters is in inductive power transfer (IPT) systems. IPT systems are a well-known area of established technology (for example, wireless charging of electric toothbrushes) and developing technology (for example, wireless charging of handheld devices on a ‘charging mat’).

IPT systems will typically include an inductive power transmitter and an inductive power receiver. The inductive power transmitter includes a transmitting coil or coils, which are driven by a suitable transmitting circuit to generate an alternating magnetic field. The alternating magnetic field will induce a current in a receiving coil or coils of the inductive power receiver. The received power may then be used to charge a battery, or power a device or some other load associated with the inductive power receiver. Further, the transmitting coil and/or the receiving coil may be connected to a resonant capacitor to create a resonant circuit. A resonant circuit may increase power throughput and efficiency at the corresponding resonant frequency.

However currently available inductive power receivers may still suffer from significant power losses and/or large foot prints. Accordingly, the present invention may provide the public with a useful choice.

### SUMMARY

According to an example embodiment there is provided an inductive power receiver comprising:
a power pick up stage; and
a power rectification and regulation stage including a rectifier having a plurality of control devices, wherein at least one of the control devices is a controllable AC switch,
wherein the receiver is configured to switch the at least one AC switch according to an open circuit control strategy.

It is acknowledged that the terms “comprise”, “comprises” and “comprising” may, under varying jurisdictions, be attributed with either an exclusive or an inclusive meaning. For the purpose of this specification, and unless otherwise noted, these terms are intended to have an inclusive meaning—i.e. they will be taken to mean an inclusion of the listed components which the use directly references, and possibly also of other non-specified components or elements.

Reference to any documents in this specification does not constitute an admission that those documents are prior art or form part of the common general knowledge.

### BRIEF DESCRIPTION OF THE DRAWINGS

The accompanying drawings which are incorporated in and constitute part of the specification, illustrate embodiments of the invention and, together with the general description of the invention given above, and the detailed description of embodiments given below, serve to explain the principles of the invention, in which:

FIG. 1 is a block diagram of an inductive power transfer system;

FIG. 2 is a block diagram of an example receiver;

FIG. 3 is circuit diagram of an example receiver;

FIG. 4 is a circuit diagram of an example AC switch;

FIG. 5 is circuit diagram of a further example receiver;

FIG. 6 is a graph of example waveform timings for control of the AC switches; and

FIG. 7 is circuit diagram of a still further example receiver.

### DETAILED DESCRIPTION

An inductive power transfer (IPT) system 1 is shown generally in FIG. 1. The IPT system includes an inductive power transmitter 2 and an inductive power receiver 3. The inductive power transmitter 2 is connected to an appropriate power supply 4 (such as mains power or a battery). The inductive power transmitter 2 may include transmitter circuitry having one or more of a converter 5, e.g., an AC-DC converter (depending on the type of power supply used) and an inverter 6, e.g., connected to the converter 5 (if present). The inverter 6 supplies a transmitting coil or coils 7 with an AC signal so that the transmitting coil or coils 7 generate an alternating magnetic field. In some configurations, the transmitting coil(s) 7 may also be considered to be separate from the inverter 5. The transmitting coil or coils 7 may be connected to capacitors (not shown) either in parallel or series to create a resonant circuit.

A controller 8 may be connected to each part of the inductive power transmitter 2. The controller 8 may be adapted to receive inputs from each part of the inductive power transmitter 2 and produce outputs that control the operation of each part. The controller 8 may be implemented as a single unit or separate units, configured to control various aspects of the inductive power transmitter 2 depending on its capabilities, including for example: power flow, tuning, selectively energising transmitting coils, inductive power receiver detection and/or communications.

The inductive power receiver 3 includes a receiving coil or coils 9 connected to power conditioning circuitry 10 that in turn supplies power to a load 11. When the coils of the inductive power transmitter 2 and the inductive power receiver 3 are suitably coupled, the alternating magnetic field generated by the transmitting coil or coils 7 induces an alternating current in the receiving coil or coils 9. The receiving coil or coils 9 may be connected to capacitors (not shown) either in parallel or series to create a resonant circuit. In some inductive power receivers, the receiver may include a controller 12 which may control tuning of the receiving coil or coils 9, operation of the power conditioning circuitry 10 and/or communications.

The term “coil” may include an electrically conductive structure where an electrical current generates a magnetic field. For example inductive “coils” may be electrically conductive wire in three dimensional shapes or two dimensional planar shapes, electrically conductive material fabricated using printed circuit board (PCB) techniques into three dimensional shapes over plural PCB ‘layers’, and other coil-like shapes. The use of the term “coil”, in either singular or plural, is not meant to be restrictive in this sense. Other configurations may be used depending on the application.

The power conditioning circuitry 10 is configured to convert the induced current into a form that is appropriate for the load 11, and may include for example a power rectifier, a power regulation circuit, or a combination of both. In an example embodiment it may be desirable for the power regulation circuit to be provided in the form of open circuit control. Open circuit control typically involves a switch in series with the load to thereby control the load current (compared to short circuit control where the switch is in parallel with the load and controls the load voltage).

Open circuit control commonly suffers from at least two problems. First switching losses due to switching the load current, and secondly voltage spikes occurring during switching.

International patent publication number WO0118936 (the contents of which are incorporated herein by reference) attempts to provide a solution by using zero current switching (ZCS) in the power regulation circuit, and a dissipative snubber to reduce voltage spikes. However in that case the power regulation switch is provided independently from the power rectifier, so the component count is relatively high. Also the dissipative snubber may be a source of loss within the circuit.

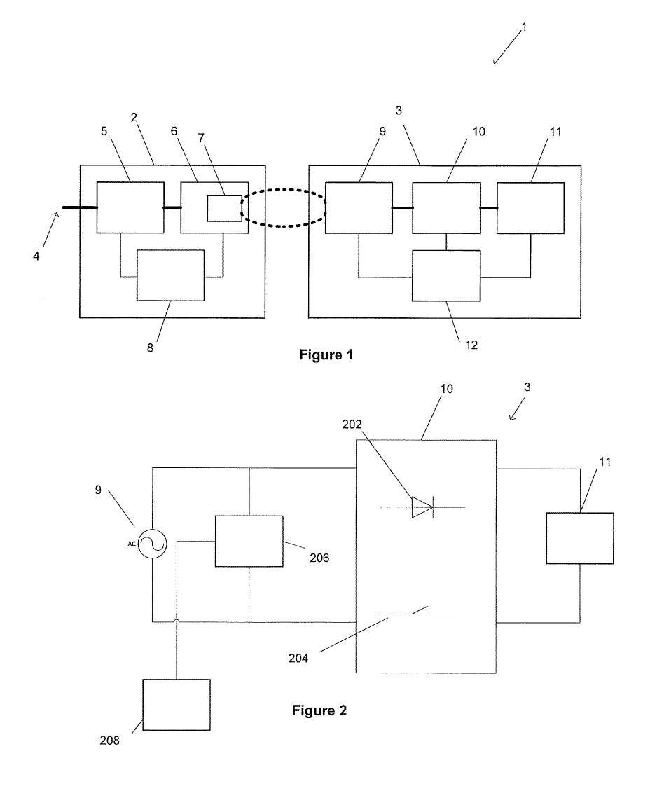

FIG. 2 shows a receiver 3 according to an example embodiment, with the power rectifier 202 combined with the power regulation circuit 204 as an integrated converter to provide ZCS open circuit control. This may reduce the component count which may allow for a smaller footprint. Furthermore voltage spikes are minimised with a regenerative snubber 206 which supplies an auxiliary circuit 208. This may minimise any losses associated with the snubber 206.

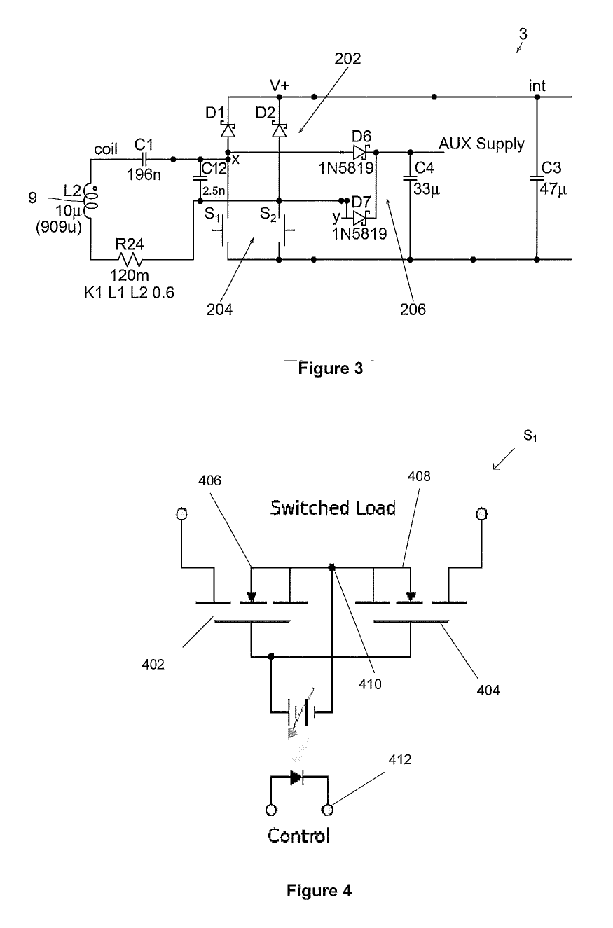

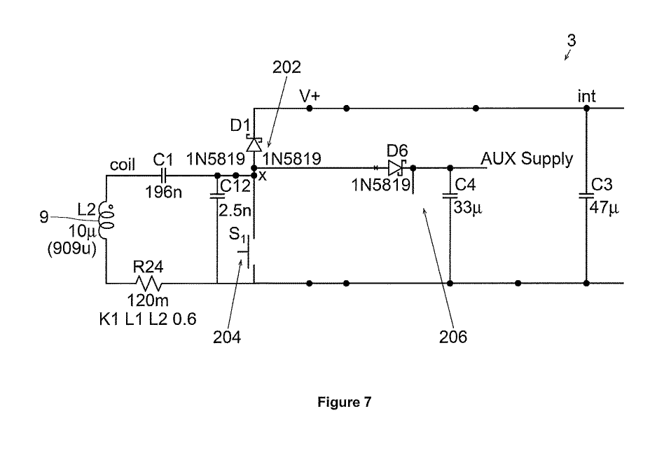

The power rectifier 202, power regulation circuit 204 and regenerative snubber 206 are shown in more detail in FIG. 3. The power pick up stage is a series tuned resonant circuit 302. The power rectifier 202 includes a full bridge rectifier with two upper diodes D₁ D₂. The two lower devices (normally diodes in a conventional rectifier) are AC switches S₁ S₂. The load 11 is the connected to the output of the power rectifier 202/power regulation circuit 204 without any further switching components required. Depending on the requirements of the application a half bridge or other rectifying circuit may be used. An example of a half bridge circuit is shown in FIG. 7.

The two AC switches S₁ S₂ also form the open circuit power regulation circuit 204 as will be described later.

An example of each AC switch S₁ (or S₂) is shown in FIG. 4. Two back to back FETs 402, 404 are connected with a common sources and their body diodes 406,408 having with a common anode 410. The gates are connected in common and provided with a digital control signal 412 to switch hard on or hard off. In this way S₁ and S₂ cannot conduct if the switch is not turned on (as would be the case with a single FET with a body diode), which allows effective open circuit control.

Alternatively AC switch S₁ S₂ could be a single transistor that does not include a body diode.

The regenerative snubber 206 includes two diodes D₆ D₇ connected in parallel to the resonant tank and a smoothing capacitor C₄. The value of C₄ may be chosen according to the requirements of the application. For example in a receiver designed for a mobile phone, C₄ may be chosen to keep the voltage spikes caused by switching within 1% of the output voltage, such as a value of 33 μF. By avoiding the resistor in a dissipative snubber losses are minimised, and the resulting energy stored in the capacitor is used by the auxiliary circuit 208. The auxiliary circuit 208 may for example include a housekeeping circuit—e.g., includes control for S₁ and S₂.

An alternative power rectifier 202, power regulation circuit 204 and regenerative snubber 206 is shown in FIG. 5. The configuration is generally similar to FIG. 3. However the power rectifier 202 includes a full bridge rectifier with two lower diodes D₃ D₄. The two upper devices (normally diodes in a conventional rectifier) are AC switches S₁ S₂.

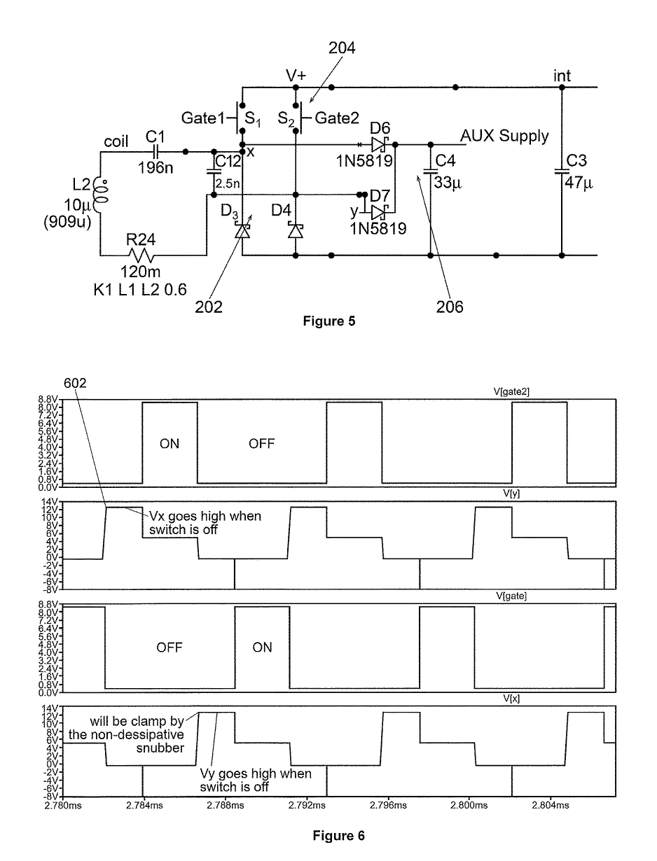

The control of the two AC switches S₁ S₂ in FIG. 5 is now described with reference to FIG. 6. The voltage at the anode of D₆ (Vₓ) goes high when S₁ is switched off by applying a low signal at Gate₁. Vₓ then drops to an intermediate voltage when S₂ is switched on by applying a high signal at Gate₂. Finally Vₓ drops back to zero when S₂ is switching off by applying a low signal at Gate₂. The voltage at the anode of D₇ (V_{y}) follows a similar voltage profile with the opposite switching of S₂ and S₁.

The voltage spike in Vₓ or V_{y} that would normally occur when both switches are switched off is clamped 602 by D₆/D₇ and C₄.

As the load increases, the duty cycle of the switches is increased until the maximum duty cycle is reached, defined by V_{y} and Vₓ (e.g.: 50%).

While the present invention has been illustrated by the description of the embodiments thereof, and while the embodiments have been described in detail, it is not the intention of the Applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of the Applicant's general inventive concept.

1. An inductive power receiver comprising:
a power pick up stage; and
a power rectification and regulation stage including a rectifier having a plurality of control devices, wherein at least one of the control devices is a controllable AC switch,
wherein the receiver is configured to switch the at least one AC switch according to an open circuit control strategy.

2. The inductive power receiver in claim 1 wherein receiver is configured to switch the AC switch with zero current switching.

3. The inductive power receiver in claim 1 wherein the other control devices are diodes.

4. The inductive power receiver in claim 1 wherein the AC switch is a pair of FETs connected with a common gate and common source.

5. The inductive power receiver in claim 1 further comprising a snubber connected in parallel with the power pick up stage.

6. The inductive power receiver in claim 5 wherein the snubber is a regenerative snubber.

7. The inductive power receiver in claim 5 wherein the snubber is configured to supply power to an auxiliary circuit.

8. The inductive power receiver in claim 1 wherein the power pick up stage is a series tuned resonant circuit.

9. The inductive power receiver in claim 1 wherein the rectifier is a full bridge rectifier, and two of the control devices are diodes and two are AC switches.
